(19) United States
(12) Patent Application Publication
(10) Pub. No.: US 2008/0048150 A1
(43) Pub. Date: Feb. 28, 2008

(54) Method for producing liquid crystal polymer molded article

(75) Inventors: Tomoya Hosoda, Tsukuba-shi (JP); Satoshi Okamoto, Tsukuba-shi (JP); Shiro Katagiri, Tsukuba-shi (JP)

Correspondence Address: FOLEY AND LARDNER LLP;SUITE 500, 3000 K STREET NW, WASHINGTON, DC, 20007, US

(73) Assignee: SUMITOMO CHEMICAL COMPANY. LIMITED

(21) Appl. No.: 11/892,102

(22) Filed: Aug. 20, 2007

(30) Foreign Application Priority Data
Aug. 22, 2006 (JP) 2006-225057
Mar. 27, 2007 (JP) 2007-081164

(51) Int. Cl. B29C 45/00; C09K 19/54

(52) U.S. Cl. 252/299.5; 264/328.1

(57) ABSTRACT

A method for producing a molded article is provided, the method comprising the step of press-molding a resin composition comprising a filler and a powder of a liquid crystal polymer having a flow starting temperature of 280° C. or higher and an average particle size of 0.5 to 50 μm. In the molded article obtained by the method of the present invention, the functions provided by the filler, such as thermal conductivity and dielectric property, can be effectively and uniformly expressed.

### BACKGROUND OF THE INVENTION

1. Field of the Invention

The present invention relates to a method for producing a molded article of a resin composition comprising a filler and a powder of a liquid crystal polymer.

2. Description of the Related Art

Since a liquid crystal polymer has high heat resistance, high mechanical properties and good mold-processability, a molded article obtained from the liquid crystal polymer is applied to various uses. In order to improve such functions, it is known that a filler is mixed with the polymer, followed by molding, to obtain a molded article of the resulting mixture. For example, it has been proposed to produce a molded article of the liquid crystal polymer by injection-molding a mixture of a liquid crystal polymer and a thermal conductive filler (see, for example, Japanese Patent Application Laid-Open Publication No. 2004-51852); to produce a molded article from a mixture of a liquid crystal polymer and a filler having dielectric property to use the article as the members related to printed-wiring boards, antenna substrates or the like (see, for example, Japanese Patent Application Laid-Open Publication No. 2004-51852); and the like.

However, in the molded articles obtained by such production methods, the filler is not dispersed well, which results in difficulty of attaining the functions of fillers uniformly in entire the molded article. Especially, when the molded articles is large and has a plate shape, it is difficult to attain the functions of fillers uniformly in the thickness direction of the plate-like molded article.

### SUMMARY OF THE INVENTION

One of objects of the present invention is to provide a method for producing a molded article comprising a filler and a liquid crystal polymer and a filler, in which the dispersibility of the filler is excellent in the molded article, and the functions given by the filler can be uniformly expressed. In particular, the object is to provide a method for producing a molded article having the uniformly expressed function such as thermal conductivity and dielectric property.

Aiming at the above objections, the present inventors have intensely studied and have accomplished the present invention.

That is, the present invention provides a method for producing a molded article, the method comprising the step of press-molding a resin composition comprising a filler and a powder of a liquid crystal polymer having a flow starting temperature of 280° C. or higher and an average particle size of 0.5 to 50 μm.

Also, the present invention provides a molded article having the uniformly expressed function such as thermal conductivity and dielectric property; and provides a circuit board comprising the molded article.

It is noted that the specific dielectric constant used hereinafter is a specific dielectric constant measured at a temperature of 25° C. and a frequency of 1 GHz.

The molded articles obtained in the present invention can be advantageously used for electric and electronic component applications, particularly as circuit boards having a conductive circuit layer provided on the molded article.

In the present invention, large molded articles, which effectively and uniformly express the functions given by the filler used, can be obtained. Based on such advantages, not only the molded articles having high thermal conductivity in a thickness direction, but also the molded articles having low dielectric or high dielectric properties can be easily obtained with high productivity, and therefore, the present invention is industrially very useful.

### DETAILED DESCRIPTION OF THE PREFERRED EMBODIMENTS

In the present invention, a molded article is produced by a method comprising the step of press-molding a resin composition comprising a filler and a liquid crystal polymer. The resin composition comprises a filler and a powder of a liquid crystal polymer having a flow starting temperature of 280° C. or higher and an average particle size of 0.5 to 50 μm.

The liquid crystal polymer can be in a molten phase having optical anisotropy (showing liquid crystalline properties). Among liquid crystal polymers, wholly aromatic polyesters and wholly aromatic poly(ester-amides) are preferable, because they have high mechanical strength and heat resistance.

Examples of the preferable liquid crystal polymer include:

(I) polymers having structure units derived from an aromatic hydroxycarboxylic acid, structure units derived from an aromatic dicarboxylic acid, and structure units derived from an aromatic diol;

(II) polymers having structure units derived from different kinds of aromatic hydroxycarboxylic acids;

(III) polymers having structure units derived from an aromatic dicarboxylic acid and structure units derived from an aromatic diol;

(IV) polymers obtained by reacting a polyester such as polyethylene terephthalate with an aromatic hydroxycarboxylic acid;

(V) the polymers (I) wherein a part or all of the structure units derived from the aromatic diol are replaced by structure units derived from an aromatic amine having a phenolic hydroxyl group or structure units derived from an aromatic diamine;

(VI) the polymers (I) or (V) wherein a part of the structure units derived from the aromatic hydroxycarboxylic acid is replaced by structure units derived from an aromatic aminocarboxylic acid, and the like.

The aromatic hydroxycarboxylic acid, the aromatic aminocarboxylic acid, the aromatic dicarboxylic acid, the aromatic diol, the aromatic diamine and the aromatic amine having a phenolic hydroxyl group, which can be used as raw materials for deriving the above-mentioned structure units, may be exchanged with derivatives of esters or amides corresponding thereto when the liquid crystal polymer is produced.

Examples of the aromatic hydroxycarboxylic acid may include p-hydroxybenzoic acid, m-hydroxybenzoic acid, 2-hydroxy-6-naphthoic acid, 2-hydroxy-3-naphthoic acid, 1-hydroxy-4-naphthoic acid, 4-hydroxy-4′-carboxydiphenylether, 2,6-dichloro-p-hydroxybenzoic acid, 2-chloro-p-hydroxybenzoic acid, 2,6-difluoro-p-hydroxybenzoic acid, 4-hydroxy-4′-biphenylcarboxylic acid, and the like. They may be used alone or as a combination of two or more.

Examples of the aromatic diol may include 4,4′-dihydroxybiphenyl, hydroquinone, resorcin, methylhydroquinone, chlorohydroquinone, acetoxyhydroquinone, nitrohydroquinone, 1,4-dihydroxynaphthalene, 1,5-dihydroxynaphthalene, 1,6-dihydroxynaphthalene, 2,6-dihydroxynaphthalene, 2,7-dihydroxynaphthalene, 2,2-bis(4-hydroxyphenyl)propane, 2,2-bis(4-hydroxy-3,5-dimethylphenyl)propane, 2,2-bis(4-hydroxy-3,5-dichlorophenyl)propane, 2,2-bis(4-hydroxy-3-methylphenyl)propane, 2,2-bis(4-hydroxy-3-chlorophenyl)propane, bis-(4-hydroxyphenyl)methane, bis-(4-hydroxy-3,5-dimethylphenyl)methane, bis-(4-hydroxy-3,5-dichlorophenyl)methane, bis-(4-hydroxy-3,5-dibromophenyl)methane, bis-(4-hydroxy-3-methylphenyl)methane, bis-(4-hydroxy-3-chlorophenyl)methane, 1,1-bis(4-hydroxyphenyl)cyclohexane, bis-(4-hydroxyphenyl)ketone, bis-(4-hydroxy-3,5-dimethylphenyl)ketone, bis-(4-hydroxy-3,5-dichlorophenyl)ketone, bis-(4-hydroxyphenyl)sulfide, bis-(4-hydroxyphenyl)sulfone, and the like. They may be used alone or as a combination of two or more.

Examples of the aromatic dicarboxylic acid may include terephthalic acid, isophthalic acid, 2,6-naphthalene dicarboxylic acid, 1,5-naphthalene dicarboxylic acid, 4,4′-biphenyl dicarboxylic acid, methyl terephthalic acid, methylisophthalic acid, diphenylether-4,4′-dicarboxylic acid, diphenylsulfone-4,4′-dicarboxylic acid, diphenylketone-4,4′-dicarboxylic acid, 2,2′-diphenylpropane-4,4′-dicarboxylic acid, and the like. They may be used alone or as a combination of two or more.

Examples of the aromatic aminocarboxylic acid may include p-aminobenzoic acid, m-aminobenzoic acid, 2-amino-6-naphthoic acid, 2-amino-3-naphthoic acid, 1-amino-4-naphthoic acid, 2-chloro-p-aminobenzoic acid, and the like. They may be used alone or as a combination of two or more.

Examples of the aromatic amine having a phenolic hydroxyl group may include, p-aminophenol, 3-aminophenol, p-N-methylaminophenol, 3-methyl-4-aminophenol, 2-chloro-4-aminophenol, and the like. They may be used alone or as a combination of two or more.

Examples of the aromatic diamine may include 1,4-phenylenediamine, 1,3-phenylenediamine, 4,4′-diaminodiphenylether, and the like. They may be used alone or as a combination of two or more.

In view of improving thermal conductivity of the resulting molded article, it is preferred to use
p-hydroxybenzoic acid and/or 2-hydroxy-6-naphthoic acid (as the aromatic hydroxycarboxylic acid);
an aromatic diol selected from the group consisting of 4,4′-dihydroxybiphenyl, hydroquinone, resorcin and 2,6-dihydroxynaphthalene;
an aromatic dicarboxylic acid selected from the group consisting of terephthalic acid, isophthalic acid and 2,6-naphthalene dicarboxylic acid; and
p-aminobenzoic acid and/or 2-amino-6-naphthoic acid (as the aromatic aminocarboxylic acid) as the raw materials for preparing the liquid crystal polymer.

Examples of more preferable liquid crystal polymer include:

(1) liquid crystal polymers having structure units derived from p-hydroxybenzoic acid, structure units derived from 4,4′-dihydroxybiphenyl, structure units derived from terephthalic acid and structure units derived from isophthalic acid;

(2) liquid crystal polymers having structure units derived from p-hydroxybenzoic acid, structure units derived from hydroquinone, structure units derived from 4,4′-dihydroxybiphenyl, structure units derived from terephthalic acid and structure units derived from 2,6-naphthalene dicarboxylic acid;

(3) liquid crystal polymers having structure units derived from p-hydroxybenzoic acid, structure units derived from hydroquinone, structure units derived from terephthalic acid and structure units derived from 2,6-naphthalene dicarboxylic acid;

(4) liquid crystal polymers having structure units derived from 2-hydroxy-6-naphthoic acid, structure units derived from p-hydroxybenzoic acid, structure units derived from 4,4′-dihydroxybiphenyl and structure units derived from terephthalic acid;

(5) liquid crystal polymers having structure units derived from 2-hydroxy-6-naphthoic acid, structure units derived from 4,4′-dihydroxybiphenyl and structure units derived from 2,6-naphthalene dicarboxylic acid;

(6) liquid crystal polymers having structure units derived from 2-hydroxy-6-naphthoic acid, structure units derived from hydroquinone, structure units derived from terephthalic acid and structure units derived from 2,6-naphthalene dicarboxylic acid;

(7) liquid crystal polymers having structure units derived from 2-hydroxy-6-naphthoic acid, structure units derived from 2,6-dihydroxynaphthalene and structure units derived from 2,6-naphthalene dicarboxylic acid;

(8) liquid crystal polymers having structure units derived from 2-hydroxy-6-naphthoic acid, structure units derived from 2,6-dihydroxynaphthalene, structure units derived from terephthalic acid and structure units derived from 2,6-naphthalene dicarboxylic acid; and

(9) liquid crystal polymers having structure units derived from p-hydroxybenzoic acid and structure units derived from 2-hydroxy-6-naphthoic acid.

In view of good processability, the liquid crystal polymer preferably has the structure units derived from the aromatic hydroxycarboxylic acid in the amount of from 30 to 70% by mole, more preferably in the amount of from 40 to 65% by mole, most preferably in the amount of from 50 to 60% by mole, on the basis of total amount of the structure units forming the liquid crystal polymer.

The liquid crystal polymer having the structure units derived from the aromatic hydroxycarboxylic acid in the above-mentioned range expresses high liquid crystalline properties in a molded article obtained by the press molding in the present invention and also has further improved processability.

The compounds which provides the above-mentioned structural units may be ester-forming or amide-forming derivatives of the acid or amine compounds mentioned above.

The ester-forming or amide-forming derivatives of the compounds having carboxylic groups may be compounds which can promote esterification or amidation reaction (such as a chloride or an anhydride); esters of carboxylic acids with alcohols or ethylene glycols which can form polyesters or polyamides by transesterification or amide-exchange reaction.

The ester-forming or amide-forming derivatives of the compounds having phenoic hydroxyl groups may be compounds, the phenoic hydroxyl groups of which forms esters with carboxylic acids which can form polyesters or polyamides by transesterification or amide-exchange reaction.

The ester-forming or amide-forming derivatives of the compounds having amino groups may be compounds, the amino groups of which forms amides with carboxylic acids which can form polyesters or polyamides by transesterification or amide-exchange reaction.

The structure units derived from the aromatic diol and the structure units derived from the aromatic dicarboxylic acid may contribute to express liquid crystalline properties depending on a copolymerization molar ratio thereof to the structure units derived from the aromatic hydroxycarboxylic acid. A preferable copolymerization molar ratio, the structure units derived from the aromatic diol:the structure units derived from the aromatic dicarboxylic acid, is within a range of 85:100 to 100:85.

Production methods of the liquid crystal polymer are not particularly limited. For example, the liquid crystal polymer can be obtained by a method in which a compound having an amino group or a phenolic hydroxyl group selected from aromatic hydroxycarboxylic acids, aromatic aminocarboxylic acids, aromatic diols, aromatic diamines and aromatic amines having a phenolic hydroxyl group is acylated with a fatty acid anhydride to produce an acylated product; and the resulting acylated product is ester- or amide-exchanged with a compound having a carboxyl group selected from aromatic hydroxycarboxylic acids having a carboxyl group, aromatic aminocarboxylic acids and aromatic dicarboxylic acids, and the like.

Examples of the fatty acid anhydride include lower fatty acid anhydrides such as acetic anhydride and propionic anhydride. Acetic anhydride is preferably used from the viewpoints of cost and handling. When the phenolic hydroxyl group and/or amino group are/is acylated, the amount of the fatty acid anhydride is preferably from 1.05 to 1.1 equivalents based on the total equivalent of the phenolic hydroxyl group and amino group. The acylation reaction is preferably carried out at a temperature of from 130 to 180° C. for 30 minutes to 20 hours, more preferably at a temperature of from 140 to 160° C. for 1 to 5 hours. The polycondensation reaction by the ester exchange reaction or amide exchange reaction are preferably conducted while the reaction temperature is elevated at a rate of 0.1 to 50° C./minute within a temperature range of from 130 to 400° C., more preferably at a rate of 0.3 to 5° C./minute within a temperature range of from 150 to 350° C. In addition, after the polycondensation reaction is completed, a solid phase polymerization may be performed to improve various physical properties of the resulting polymer.

Using the thus-obtained liquid crystal polymers, a powder of a liquid crystal polymer having a flow starting temperature of 280° C. or higher and an average particle size of 0.5 to 50 μm can be obtained. For example, a method disclosed in Japanese Patent Application Laid-Open Publication No. 2003-268121 can be conducted to obtain the powder having the average particle of 0.5 to 50 μm. In this method, the liquid crystal polymer (prepolymer) having a flow starting temperature of 200° C. to 270° C. is first finely pulverized to prepare the powder of the liquid crystal polymer having a flow starting temperature of 280° C. or higher. The pulverization is preferably carried out by mechanical pulverization.

The flow starting temperature of a liquid crystal polymer used herein is a temperature at the time when the melt viscosity of the liquid crystal polymer becomes 4,800 Pa·s (48,000 poises), which is measured using a capillary rheometer equipped with a dice having an inside diameter of 1 mm and a length of 10 mm, when the polymer is extruded from a nozzle at a rate of temperature rise of 4° C./minute under a load of 9.8 MPa (100 kg/cm²). This temperature is one of the parameters showing a molecular weight of a liquid crystal polymer, the parameter of which is well known by those skilled in the art (see, for example, “Liquid Crystal Polymer—Synthesis, Molding and Application—” edited by Naoyuki Koide, pp. 95-105, CMC, published on Jun. 5, 1987). The liquid crystal polymers having a flow starting temperature of from 200 to 270° C. can be easily obtained by, for example, controlling the polycondensation reaction conditions in the ester exchange reaction or amide exchange reaction.

The liquid crystal polymer obtained by the above-described method after conducting the polycondensation reaction may be in the shape of a lump, and such a lump of the polymer can be pulverized into a fine powder having a desired average particle size, which is suitable to be used in the present invention. It is preferred that the obtained lump polymer is first roughly pulverized and is then finely pulverized again to produce a fine powder of the polymer. For roughly pulverizing the polymer, a jaw crusher, a gyratory crusher, a cone crusher, a roll crusher, an impact crusher, a hammer crusher, a primary cutter or the like may be used. Also, for finely pulverizing the polymer, a rod mill, a ball mill, a vibration rod mill, a vibration ball mill, a pan mill, a roller mill, an impact mill, a disc mill, a mixing and shearing mill, a fluid-energy mill, a jet mill or the like may be used. Conditions for roughly and finely pulverizing are not particularly limited. The pulverization is more preferably conducted under dry conditions than wet conditions, because the liquid crystal polymer might be hydrolyzed in the wet conditions. In the rough pulverization, it is preferred to pulverize the polymer so as to have an average particle size of about 0.5 to 5 mm, from the viewpoint of handling. This is because the roughly pulverized polymer having such a particle size can be easily fed into a fine pulverizing machine. When, for example, the fine pulverization is performed using a jet pulverizer, the pulverization is preferably carried out at a treating rate of 0.5 kg/hour or more under a nozzle pressure of 0.5 to 1 MPa, from the viewpoint of productivity. The conditions for fine pulverization can be optimized depending on the type of the pulverizer used, and the like. In addition, it is preferred to conduct the rough or fine pulverization at room temperature such as about 25° C., from the viewpoint of handling.

The resulting finely pulverized powder of the liquid crystal polymer, which has an average particle size of 0.5 to 50 μm, may be heat-treated to adjust its flow starting temperature of 280° C. or higher. Examples of the heat-treatment method include a method in which the finely pulverized particles are stirred at a temperature of 150 to 350° C. in a solvent having a high boiling point such as a mixture of biphenyl and diphenylether or diphenylsulfone, and then, the high-boiling point solvent used is removed; a method in which the particles are heat-treated at a temperature of 150 to 350° C. for 1 to 20 hours under an inert gas atmosphere or under reduced pressure; and the like. When the heat-treatment is performed at lower than 150° C., the effect for improving the flow starting temperature tends to be lowered. When the heat-treatment is performed at a temperature of higher than 350° C., the liquid crystal polymer per se may be decomposed. Examples of the inert gas include nitrogen, helium, argon, carbon dioxide gas and the like. Examples of the apparatus used in the heat-treatment include dryers, reactors, inert ovens, mixers, electric furnaces, and the like.

When the finely pulverized powder of the liquid crystal polymer is heat-treated, it is preferred that the rate of temperature rise and the treatment temperature in the heat-treatment are appropriately selected so as not to fuse the fine powder of the liquid crystal polymer. If the powder is fused, the improvement of the flow starting temperature tends to be inhibited. When the powder having a large particle size by fusion due to the heat-treatment is obtained, however, such a powder is cracked again to bring the particle size back to the size of the powder before the heat-treatment, and then the resulting powder can be used. For cracking the fused powder, mechanical pulverization is preferred. The cracking of the fused powder is preferably conducted under an inert gas atmosphere or under a reduced pressure atmosphere. Examples of the inert gas are the same as mentioned above.

As to the method for forming the powder of the liquid crystal polymer by the combination method of the pulverization and the heat-treatment described above, the method in which the finely pulverized product having an average particle size of 0.5 to 50 μm, and then the obtained product is heat-treated was described above. Alternatively, the powder of the liquid crystal polymer may be prepared by first roughly pulverizing the liquid crystal polymer to produce a roughly pulverized product, then heat-treating the roughly pulverized product so as to have a suitable flow starting temperature of the liquid crystal polymer, and finally, finely pulverizing the product to obtain a powder having a desired average particle size. In this case, the same conditions as mentioned in the heat-treatment and the fine pulverization methods as described above may be employed.

The flow starting temperature of the powder of the liquid crystal polymer in the present invention is 280° C. or higher, is preferably in the range of 280 to 420° C., and is more preferably in the range of 310 to 390° C. in view of heat resistance and mechanical properties of the powder. When the flow starting temperature is lower than 280° C., the resulting molded article tends to generate outgas and to be expanded when exposed to a heat-treatment process such as solder reflow, undesirably. On the other hand, when the flow starting temperature is higher than 420° C., the film strength tends to lower.

The average particle size of the powder of the liquid crystal polymer is, as described above, in the range of from 0.5 to 50 μm, more preferably in the range of from 0.5 to 30 μm, and most preferably in the range of from 0.5 to 10 μm. When the average particle size of the powder of the liquid crystal polymer is larger than 50 μm, it may be difficult to uniformly disperse fillers in the molded article, resulting in that functions of the fillers is difficult to be uniformly expressed. Also, when the average particle size is too large, the appearance of the molded article may be worsened due to uneven dispersion of the fillers in the molded article. On the other hand, the smaller the average particle size, the better the dispersibility of the filler, while the particle size is preferably in the range of from 0.5 μm or more from the viewpoint of handling.

A resin composition used in the present invention comprises a filler in addition to the powder of the liquid crystal polymer.

The amount of the filler used in the composition depends on the desired use, and is preferably in a range of from 1 to 98% by weight, more preferably in a range of from 5 to 80% by weight, on the basis of the total weight of the powder of the liquid crystal polymer and the filler, and the amount is preferably in a range of from 20 to 70% by weight from the viewpoint of the improvement of moldability. According to the present invention, a high filling amount of an inorganic filler, that is, molded articles containing the filler in a high content such as 60% by weight or more of the total weight of the fine powder of the liquid crystal polymer and the filler, which has hitherto been relatively difficult by injection molding, can also be achieved.

The filler may be a fibrous, granular or plate-like organic or inorganic filler. Examples of the fibrous filler include inorganic fibrous materials such as glass fiber, asbestiform fiber, silica fiber, silica-alumina fiber, carbon fiber, zirconia fiber, boron nitride fiber, silicon nitride fiber, boron fiber, carbon titanic acid fiber, fibers of silicate salt such as wollastonite, magnesium sulfate fiber, aluminum borate fiber, and fibrous products containing a metal such as stainless steel, aluminum, titanium, copper and brass.

Examples of the granular filler include carbon black, graphite, silica, porous silica, quartz powder, glass beads, milled glass fiber, glass balloon, glass powder, calcium silicate, aluminum silicate, kaolin, clay, diatom earth, silicate salts such as wollastonite, aluminum nitride, boron nitride, dielectric ceramic powder, metal oxides such as ferric oxide, titanium oxide, zinc oxide, nickel oxide, antimony trioxide, magnesium oxide, silicon oxide and alumina; metal carbonates such as calcium carbonate and magnesium carbonate; metal sulfates such as calcium sulfate and barium sulfate; ferrites such as manganese-zinc ferrite, nickel-zinc ferrite, barium ferrite and strontium ferrite; silicon carbide, silicon nitride, boron nitride, various metal powders such as iron and nickel, alloy powders including the metals listed above, and the like.

Examples of the plate-like filler include mica, glass flake, talk, plate-like alumina, various metal foils, and the like.

Examples of the organic filler include heat-resistant and high-strength synthetic fibers such as aromatic polyester fibers, liquid crystal polymer fibers, aromatic polyamide and polyimide fibers. In addition, organic fibrous materials having a high melting point such as polyamide, fluororesins, polyester resins and acrylic resins may be used.

These inorganic and organic filler may be used alone or as a combination or two or more. The combination of the fibrous filler and the granular or plate-like filler is preferred because such a combination tends to express all of high mechanical strength, dimensional accuracy and electric properties.

The average particle size of the fillers is preferably in the range of from about 0.5 to about 50 μm, more preferably in the range of from 1 to 30 μm, from the viewpoint of improvement of miscibility with the fine powder of the liquid crystal polymer.

According to the present invention, the filler can give various functions to a large molded article, and the filler is selected according to the desired functions.

For example, from the viewpoint of mechanical strength of the resulting molded article, the fibrous fillers such as glass fiber, alumina fiber, carbon fiber and aluminum borate fiber, or the plate-like fillers such as mica, glass flake, talc and plate-like alumina are preferably used, and glass fiber, alumina fiber, carbon fiber, mica and talc are more preferably used.

From the viewpoint of magnetic properties of the resulting molded article, the ferrites such as manganese zinc ferrite, nickel zinc ferrite, barium ferrite, and strontium ferrite, various metal powders such as iron and nickel, or the alloy powders thereof are preferably used, and manganese zinc ferrite, nickel zinc ferrite, various metal powders such as iron and nickel, and the alloy powders including these metals are more preferably used.

From the viewpoint of thermal conductivity of the resulting molded article, alumina, silica, aluminum nitride, boron nitride, magnesium oxide, silicon nitride, silicon oxide, silicon carbide, boron nitride, metal powders and metal oxides may be used.

Also, from the viewpoint of dielectric properties of the resulting molded article, a filler containing a high dielectric material or a low dielectric material (hereinafter can be referred to as a “dielectric filler”) may be used. Examples of the filler containing a high dielectric material include, among the examples listed above, dielectric ceramic powders having a specific dielectric constant of 100 or more, more specifically, dielectric ceramic powders containing at least one metal selected from the group consisting of titanium, barium, strontium, zinc, potassium, calcium, zirconium, tin, neodymium, bismuth, samarium, lithium, and tantalum.

On the other hand, examples of the filler containing a low dielectric material include fillers containing so-called hollow bodies, and fillers containing a fluororesin, which is a low dielectric resin.

The dielectric fillers used for giving the dielectric property to the molded article can be selected according to a desired specific dielectric constant of the molded article. For example, in molded articles formed from a simple composition containing the liquid crystal polymer and the dielectric filler, a specific dielectric constant (e) of the molded article can be predicted from the following equation:
log e=V1·log e1+V2·log e2 (1)
wherein e1 represents the specific dielectric constant of the liquid crystal polymer, e2 represents the specific dielectric constant of the filler, V1 is the volume percentage of the liquid crystal polymer in the molded article, and V2 is the volume percentage of the filler in the molded article. In the present invention, when a molded article having the dielectric property is intended, the specific dielectric constant of a molded article to be obtained can also be predicted from a logarithmic mixing rule widely used in the art, such as the equation (1).

Among the molded articles using the liquid crystal polymer, the molded articles of the present invention, as described above, are particularly effectively applied to the thermal conductive molded articles, the high dielectric molded articles, and the low dielectric molded articles.

First, the thermal conductive molded article will be described in detail. The thermal conductive molded articles obtained in the present invention have high thermal conductivity while maintaining good surface appearance (appearance property) or warpage resistance.

The filler to be used, which has high thermal conductivity, may be selected from the fillers listed above, and the inorganic fillers having a coefficient of thermal conductivity of 10 W/mK or more at 20° C. are preferably used. Specifically, examples thereof include alumina, silica, aluminum nitride, boron nitride, magnesium oxide, silicon nitride, silicon oxide, and the like. Among these, the filler containing alumina as a main component is preferably used in view of low cost. Specifically, it is preferred to use a filler containing alumina in the amounts of 80% by weight or more based on the filler.

The molded article obtained in the present invention using such a filler is particularly suitable for use in a heat sink and the like, because the molded article has high thermal conductivity in a thickness direction thereof, which is difficult to be produced by the conventional injection molding. A printed-wiring board comprising the molded article obtained in the present invention as an insulating layer can efficiently release heat generated in operating the wiring board.

Next, the molded articles expressing high dielectric property will be described.

The dielectric ceramic powders listed above are preferable fillers for preparing the molded article with high dielectric property. In order to obtain the molded article having a higher specific dielectric constant, powders containing strontium titanate, barium titanate, calcium titanate, or magnesium titanate are preferably used, because they have a higher specific dielectric constant. Among them, the powders containing strontium titanium or barium titanium are more preferably used. The molded articles containing the preferable dielectric ceramic powders can have high dielectric property with a high specific dielectric constant such as 4.5 or more (measurement frequency: 1 GHz). Further, by controlling the amount of the filler, the molded article having a specific dielectric constant of 8.0 or more can also be obtained. Since the molded article having high dielectric property is effective in miniaturization of antennas when used in antenna substrates, for example. When small members are divided from a large molded article obtained in the present invention, the number of members per production lot can be increased, thus resulting in increased productivity of the small members. When the antennas are to be miniaturized, the specific dielectric constant of the molded article is more preferably 10 or more. Although the upper limit of the specific dielectric constant of the high dielectric molded article varies depending on the specific dielectric constant and the amount of the filler used, the specific dielectric constant of the high dielectric molded article is preferably 100 or less, more preferably 50 or less, considering a practical use of the article.

The antenna substrate refers to a substrate which can be used for producing GPS antennas, wireless LAN antennas, Bluetooth antennas, UWB antennas, millimeter wave radar antennas and the like, and the antennas can be produced by forming electrodes and the like on the substrate by a mounting technique. When the molded article of the present invention has high dielectric property, good electric property can be attained, and high productivity can be realized in industrial production of the antenna substrates.

Next, the molded articles expressing low dielectric property will be described.

In preparing such a molded article, a hollow filler such as porous silica and glass balloon are preferably used. By suitably optimizing the kind and amount of the filler, the molded article having a low specific dielectric constant of 2.8 or less (measurement frequency: 1 GHz) can be obtained. In using the hollow filler to prepare the molded article having a lower dielectric property, the advantages of the present invention is typically observed, since the breakage of the hollow filler can be remarkably reduced during the production of the article in the present invention, while in the conventional injection molding the hollow filler is easily broken when kneaded with the liquid crystal polymer. The molded article having a lower dielectric property obtained in the present invention, particularly printed-wiring boards produced by forming a conductor layer on a plate-like large molded article, is useful for reducing transmission loss of an electric signal. From this viewpoint, the specific dielectric constant of the molded article is more preferably 2.6 or less, most preferably 2.4 or less. In the present invention, the breakage of the hollow filler can be remarkably reduced, and therefore, the functions of the hollow filler can be efficiently achieved, which results in lowering the dielectric constant of the molded article. Although the lower limit of the specific dielectric constant of the low dielectric molded article varies depending on the specific dielectric constant and the amount of the filler used, the specific dielectric constant of the low dielectric molded article is preferably 1.8 or more, more preferably 2.0 or more, considering a practical use of the article.

In the present invention, the above-described molded article can be obtained by the method comprising the step of press-molding a resin composition comprising a filler and a powder of a liquid crystal polymer mentioned above. The composition may contain additives in addition to the filler listed above so long as the desirable effects obtained by the filler are not impaired. Examples of the additive include coupling agents, antioxidants, ultraviolet absorbers, heat-stabilizers and coloring agents.

It is preferred that the processing in the press-molding is carried out under the conditions in which the processing temperature (Tp) upon press-molding and the flow starting temperature (T_{FST}) of the resin composition (which corresponds to the flow starting temperature of the liquid crystal polymer contained in the resin composition) satisfy the following formula:
T_{FST}−10 [° C.]≦Tp [° C.]≦T_{FST}+100 [° C.].

When Tp is lower than (T_{FST}−10)° C., the resin composition tends to insufficiently melt, and it may be difficult to obtain a molded article having sufficient strength. On the other hand, when Tp is higher than (T_{FST}+100)° C., the liquid crystal polymer tends to deteriorate by thermal decomposition.

The pressure upon press molding is preferably 400 kgf/cm² or less, is more preferably 200 kgf/cm² or less, and is most more preferably 100 kgf/cm², from the viewpoint of the reduction of warpage of the molded articles. The retention time at the highest temperature upon press molding is preferably from 1 to 180 minutes, from the viewpoint of processability and productivity, and is more preferably from 5 to 120 minutes.

The press molding may be performed in vacuum or under an inert gas atmosphere such as nitrogen gas.

In the present invention, various large molded articles, in particular, large molded articles having high thermal conductivity or good dielectric property, can be easily produced. The obtained molded article has high warpage resistance and good appearance even if the article has a large size such as 250×250 mm. It is difficult to obtain such a large-size molded article of the liquid crystal polymer by the conventional molding method including injection-molding, which is widely used in molding of liquid crystal polymer.

In addition to various large molded articles, the resin composition can also be formed into relatively small molded articles and film-shaped molded articles in the present invention. Further, the resin composition can be formed into any shape such as a cylindrical or quadrangular shape, or a shape of machine parts such as a gear or bearing by variously altering a mold used in press-molding, and a desired shape can be cut out of the sheet-shape molded article obtained in the present invention.

As described above, the molded articles having high thermal conductivity and/or good dielectric property are suitably used as electric or electronic parts. As one example of such parts, a circuit board will be described below.

The circuit board can be produced by forming a conductor layer on the molded article. The method for forming the conductor layer is not limited, and widely known methods may be used. For example, the conductor can be prepared on the molded article by a method in which a metal foil such as copper foil is laminated onto the molded article by heat-press; or by a method in which a metal foil is laminated onto the molded article with an adhesive.

A method in which a conductor layer formed on the molded article by a sputtering method, ion plating method, vacuum deposition method, electroless plating, and the like may also be utilized. Also, after the conductor layer is formed by the above-mentioned method, another conductor layer may be laminated by electrolytic plating and the like. Further, in order to improve the adhesion between the surface of the molded article and the conductor layer, the molded article may be subjected to various surface treatments such as an ultraviolet treatment, plasma treatment, corona treatment, acid or alkali treatment, or sandblasting treatment, before forming the conductor layer on the article.

After the conductor layer is formed, any circuit can be formed depending on various uses, and the antenna substrates or printed-wiring boards as described above can be produced by the circuit formation.

The molded articles of the present invention, as described above, are advantageously used as, particularly, members for electric or electronic parts, but may be applied to other usages.

Specifically, examples of the usage include, in addition to electric or electronic parts such as connectors, plugs, relay parts, coil bobbins, optical pickups, oscillators, and computer related parts, parts of home electric appliances such as VTR, television sets, clothes irons, air conditioners, stereo systems, vacuum cleaners, refrigerators, rice cookers, and lighting apparatuses; parts of light apparatuses such as lamp reflectors, and lamp holders; parts of acoustic products such as compact discs, laser discs, and speakers; parts of communication devices such as ferrules for an optic cable, parts of a telephone set, parts of a facsimile machine, and modems; parts of copying machines or printer-related parts such as separation claws and heater holders; machine parts such as impellers, fan gears, gears, bearings, motor parts and cases; automobile parts such as mechanical components for automobiles, engine parts, in-engine-room parts, electrical components and interior parts; kitchen utensils such as microwave-safe pots and heat-resistant dishes; materials for heat insulation or sound insulation such as floor covers and wall materials, base materials such as beam and pillars, construction materials such as roof materials, or materials for civil engineering and construction; parts for airplanes, spacecraft or space appliances; members used in radiation facilities such as atomic reactors, members used in marine facilities, tools for washing, parts for optical devices, valves, pipes, nozzles, filters, membranes, parts for medical devices and medical materials, parts for sensors, sanitary items, sports goods, leisure goods, and the like.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Applications No. 2006-225057 filed on Aug. 22, 2006 and No. 2007-81164 filed on Mar. 27, 2007, both including specification, claims and summary, are incorporated herein by reference in their entirety.

### EXAMPLES

The present invention is described in more detail by following Examples, which should not be construed as a limitation upon the scope of the present invention.

### Preparation Example 1

In a reactor equipped with a stirring device, a torque meter, a nitrogen gas inlet tube, a thermometer, and a reflux condenser were put 911 g (6.6 mole) of p-hydroxybenzoic acid, 409 g (2.2 mole) of 4,4′-dihydroxybiphenyl, 274 g (1.65 mole) of terephthalic acid, 91 g (0.55 mole) of isophthalic acid and 1,235 g (12.1 mole) of acetic acid anhydride. After the inside of the reactor was fully substituted by nitrogen gas, the temperature was elevated to 150° C. over 15 minutes under nitrogen gas stream, and reflux was continued for 3 hours while maintaining the temperature. Then, the temperature was elevated to 300° C. over 2 hours and 50 minutes while the distilled acetic acid generated as a by-product and unreacted acetic acid anhydride were distilled away. The molten content in the reactor was put into a bat at the time when the torque began to rise, which was considered as the end point of the reaction, and the content was cooled. The yield of the obtained liquid crystal polyester was 1,430 g. The liquid crystal polymer cooled to about room temperature was pulverized in an Orient VM-16 vertical type crusher, manufactured by Seishin Enterprise Co., Ltd. to give a roughly pulverized product having a particle size of 1 mm or less. The product had a flow starting temperature of 239° C., expressed optical anisotropy in a molten state at a temperature of 280° C. or more, and an average particle size of 500 μm.

### Preparation Example 2

The roughly pulverized product obtained in Preparation Example 1 (average particle size: 500 μm) was subject to heat treatment under nitrogen atmosphere by heating the product from a room temperature (about 25° C.) to 250° C. over 1 hour and then from 250° C. to 285° C. over 5 hours, and maintaining the temperature at 285° C. for 3 hours, followed by cooling. The resulting product had a flow starting temperature of 327° C.

### Preparation Example 3

The roughly pulverized product obtained in Preparation Example 1 having a flow starting temperature of 239° C. (average particle size: 500 μm) was finely pulverized in an STJ-200 jet mill, manufactured by Seishin Enterprise Co., Ltd., to produce finely pulverized particles of the liquid crystal polymer having an average particle size of 5.2 μm. The obtained finely pulverized particles were subject to heat treatment under nitrogen atmosphere by heating the product from a room temperature (about 25° C.) to 250° C. over 1 hour and then from 250° C. to 292° C. over 3 hours, and maintaining the temperature at 292° C. for 3 hours, followed by cooling. The obtained fine powder had a flow starting temperature of 326° C.

The physical properties of the molded articles obtained in Examples and Comparative Examples were evaluated by the following methods.

Warpage Distance of Molded Article:

A molded article was put on a table, and the left end of the molded article was fixed. The distance between the table and the highest point of the molded article from the table was measured to be a warpage distance. A warpage distance of 0.1 mm or less was defined as low warpage.

Solder Foaming Test of Molded Article:

A test peace, a sample for a solder foaming test (size: 50 mm×50 mm×1 mm), was prepared by cutting out of the molded article to be tested. The test peace was dipped in an H60A solder (tin: 60% and lead: 40%) at 280° C. for 60 seconds to observe whether or not the sample foamed or blistered under the conditions.

Coefficient of Thermal Conductivity of Molded Article:

A test piece for measuring a coefficient of thermal conductivity (size: 10 mm×10 mm×1 mm) was prepared by cutting out of the molded article to be tested. A coefficient of thermal diffusivity of the test piece was measured in the thickness direction thereof by using a laser flash type thermal constant measuring device (manufactured by ULVAC-RIKO, Inc., TC-7000). The specific heat of the test piece was measured by using DSC (manufactured by PERKIN ELMER, DSC7), and the specific gravity of test piece was measured by using an automatic specific gravity meter (Kanto Measure Kabushiki Kaisha, ASG-320K). Coefficient of thermal conductivity is calculated by multiplying the coefficient of thermal diffusivity by the specific heat. It is noted that the coefficient of thermal conductivity was obtained in the thickness direction of the molded article to be measured.

Specific Dielectric Constant of Molded Article:

A test piece (sample) for obtaining a specific dielectric constant (size: 10 mm×10 mm×1 mm) was prepared by cutting out of the molded article to be tested. The specific dielectric constant of the test piece was measured at a measurement frequency of 1 GHz by using an impedance analyzer (manufactured by HP, 4291A) (measurement atmosphere: 25° C. and 50% RH).

### Examples 1 and 2, and Comparative Examples 1 and 2

The roughly pulverized products of the liquid crystal polymer and the fine powders of the liquid crystal polymer obtained in Preparation Examples 1 to 3 were blended respectively with alumina particles (Advanced Alumina AA-2 manufactured by Sumitomo Chemical Co., Ltd.; number average particle size: 2 μm, alumina content: 99.6% by weight) in a ratio shown in Table 1, and then the resulting mixtures were respectively molded under the processing conditions shown in Table 1 using a pressing machine to produce stereo molded articles (size: 150 mm×150 mm×1 mm). The appearance of the stereo molded articles was observed, and the warpage distance was measured. Then, the test pieces were produced from the molded articles to conduct the solder foaming test and to obtain the Coefficient of thermal conductivity of the articles. The obtained results are shown in Table 1.

TABLE 1
Results of articles obtained by press molding.

| | Example | | Comparative Example | |
|---|---|---|---|---|
| | 1 | 2 | 1 | 2 |
| Kind of liquid | Preparation | Preparation | Preparation | Preparation |
| crystal polymer | Example 3 | Example 3 | Example 1 | Example 2 |
| Liquid crystal | 30.1 | 22.4 | 30.1 | 22.4 |
| polymer (part by | | | | |
| weight) | | | | |
| Alumina (part by | 69.9 | 77.6 | 69.9 | 77.6 |
| weight) | | | | |
| Press molding | 365 | 365 | 280 | 365 |
| temperature (° C.) | | | | |
| Press pressure | 150 | 50 | 150 | 150 |
| (kg/cm²) | | | | |
| Press time (minute) | 5 | 5 | 5 | 5 |
| Warpage distance of | 0.1 mm or less | 0.1 mm or less | 0.1 mm or less | 0.1 mm or less |
| molded article | | | | |
| Size of stereo | 150 × 150 × 1 | 150 × 150 × 1 | 150 × 150 × 1 | 150 × 150 × 1 |
| molded article (mm) | | | | |
| Surface appearance | Good | Good | Good | Color shading |
| | | | | occurred |
| Existence of foaming | Not observed | Not observed | Observed | Not observed |
| and blister in | | | | |
| Solder foaming test | | | | |
| Coefficient of | 2.1 | 3.8 | Not measured | 3.1 |
| thermal conductivity | | | | |
| (W/mK) | | | | |

### Examples 3 to 8

The fine powder of the liquid crystal polymer obtained in Preparation Example 3 was blended with strontium titanate (ST manufactured by Fuji Titanium Industry Co., Ltd; number average particle size: 1 μm) or glass balloon (S60HS manufactured by Sumitomo 3M Limited, number average particle size: 27 μm) respectively in a ratio shown in Table 2 and 3. The resulting mixtures were respectively formed into stereo molded articles (size: 150 mm×150 mm×1 mm) under processing conditions shown in Table 2 and Table 3. After the appearance of the stereo molded article was observed, the warpage distance was measured. Then, a test piece for measuring a specific dielectric constant was produced, and the specific dielectric constant was measured. The obtained results are shown in Table 2 and Table 3.

For reference, the fine powder of the liquid crystal polymer obtained in Preparation Example 3 was formed into a molded article having the same shape as above without using a filler, and the specific dielectric constant was measured in the same manner as above. The molded article had a specific dielectric constant of 3.0.

TABLE 2
Results of articles obtained by press molding.

| | Example | | |
|---|---|---|---|
| | 3 | 4 | 5 |
| Kind of liquid crystal | Preparation | Preparation | Preparation |
| polymer | Example 3 | Example 3 | Example 3 |
| Liquid crystal polymer | 51.8 | 38.6 | 28.8 |
| (% by weight) | | | |
| Strontium titanate (% | 48.2 (20% | 61.4 (30% | 71.2 (40% |
| by weight) | by volume) | by volume) | by volume) |
| Press molding | 365 | 365 | 365 |
| temperature (° C.) | | | |
| Press molding pressure | 150 | 150 | 150 |
| (kgf/cm²) | | | |
| Press molding time | 5 | 5 | 5 |
| (minute) | | | |
| Warpage distance of | 1 mm or less | 1 mm or less | 1 mm or less |
| molded article (mm) | | | |
| Size of stereo molded | 150 × 150 × 1 | 150 × 150 × 1 | 150 × 150 × 1 |
| article (mm) | | | |
| Surface appearance | Good | Good | Good |
| Specific dielectric | 9.8 | 13.4 | 19.1 |
| constant (1 GHz) | | | |

TABLE 3
Results of articles obtained by press molding.

| | Example | | |
|---|---|---|---|
| | 6 | 7 | 8 |
| Kind of liquid crystal | Preparation | Preparation | Preparation |
| polymer | Example 3 | Example 3 | Example 3 |
| Liquid crystal polymer | 77.5 | 69.4 | 60.6 |
| (% by weight) | | | |
| Glass balloon | 22.5 (40% | 30.6 (50% | 39.4 (60% |
| (% by weight) | by volume) | by volume) | by volume) |
| Press molding | 365 | 365 | 365 |
| temperature (° C.) | | | |
| Press molding pressure | 150 | 150 | 150 |
| (kgf/cm²) | | | |
| Press molding time | 5 | 5 | 5 |
| (minute) | | | |
| Warpage distance of | 1 mm or less | 1 mm or less | 1 mm or less |
| molded article (mm) | | | |
| Size of stereo molded | 150 × 150 × 1 | 150 × 150 × 1 | 150 × 150 × 1 |
| article (mm) | | | |
| Surface appearance | Good | Good | Good |
| Specific dielectric | 2.6 | 2.4 | 2.3 |
| constant (1 GHz) | | | |

### Comparative Examples 3 and 4

The roughly pulverized products of the liquid crystal polymer obtained in Preparation Examples 1 and 2 were blended in a ratio shown in Table 4 with alumina particles (Advanced Alumina AA-2 manufactured by Sumitomo Chemical Co., Ltd., number average particle size: 2 μm, alumina content: 99.6% by weight) and was kneaded by using a twin screw extruder to produce pellets. The pellets were respectively molded by using an injection molding machine (PS40EASE manufactured by Nissei Plastic Industrial Co., Ltd.) to obtain stereo molded articles (size: 64 mm×64 mm×1 mm). Then, the test pieces were produced from the molded articles to conduct the solder foaming test and to obtain the coefficient of thermal conductivity of the articles. The obtained results are shown in Table 4.

### Comparative Example 5

The roughly pulverized product of the liquid crystal polymer obtained in Preparation Example 2 was blended in a ratio shown in Table 4 with alumina particles (Advanced Alumina AA-2 manufactured by Sumitomo Chemical Co., Ltd., number average particle size: 2 μm, alumina content: 99.6% by weight) and was kneaded by using a twin screw extruder to produce pellets. The molding of the pellets was conducted using an injection molding machine (PS40EASE manufactured by Nissei Plastic Industrial Co., Ltd.), trying to produce a stereo molded article (size: 100 mm×100 mm×1 mm) larger than those obtained in Comparative Examples 3 and 4. However, the resulting molten mixture did not sufficiently flow, and such a large stereo molded article was not obtained.

TABLE 4
Results of articles obtained by injection molding.

| | Comparative Example | | |
|---|---|---|---|
| | 3 | 4 | 5 |
| Kind of liquid crystal | Preparation | Preparation | Preparation |
| polymer | Example 1 | Example 2 | Example 2 |
| Liquid crystal polymer | 30.1 | 22.4 | 22.4 |
| (part by weight) | | | |
| Alumina (part by | 69.9 | 77.6 | 77.6 |
| weight) | | | |
| Injection-molding | 365 | 365 | 365 |
| temperature (° C.) | | | |
| Size of stereo molded | 64 × 64 × 1 | 64 × 64 × 1 | (100 × 100 × 1) |
| article (mm) | | | Not obtained |
| Existence of foaming | Not observed | Not observed | Not tested |
| and blister in Solder | | | |
| foaming test | | | |
| Coefficient of thermal | 1.3 | 2.5 | Not measured |
| conductivity (W/mK) | | | |

### Example 9

The product obtained in Preparation Example 3 was blended with a strontium titanate (ST manufactured by Fuji Titanium Industry Co., Ltd; number average particle size: 1 μm) in a ratio shown in Table 5, and then the mixture was molded under processing conditions shown in Table 5 using a pressing machine to produce a stereo molded article (size: 250 mm×250 mm×1 mm). Then, the test piece was produced from the molded article to obtain the specific dielectric constant of the article. The obtained result is shown in Table 5.

TABLE 5
Results of large article obtained by press molding.

| | Example 9 |
|---|---|
| Kind of liquid crystal polymer | Preparation Example 3 |
| Liquid crystal polymer (% by weight) | 51.8 |
| Strontium titanate (% by weight) | 48.2 (20% by volume) |
| Press molding temperature (° C.) | 365 |
| Press molding pressure (kgf/cm²) | 150 |
| Press molding time (minute) | 20 |
| Warpage distance of molded article (mm) | 1 mm or less |
| Size of stereo molded article (mm) | 250 × 250 × 1 |
| Surface appearance | Good |
| Specific dielectric constant (1 GHz) | 9.8 |

1. A method for producing a molded article, the method comprising the step of press-molding a resin composition comprising a filler and a powder of a liquid crystal polymer having a flow starting temperature of 280° C. or higher and an average particle size of 0.5 to 50 μm.

2. The method according to claim 1, wherein the powder of the liquid crystal polymer has a flow starting temperature in the range of from 280° C. to 420° C.

3. The method according to claim 1, wherein the liquid crystal polymer is a wholly aromatic polyester and/or wholly aromatic poly(ester-amide).

4. The method according to claim 1, wherein the liquid crystal polymer is a wholly aromatic polyester and/or wholly aromatic poly(ester-amide) and comprises structure units derived from an aromatic hydroxycarboxylic acid in the amount of from 30 to 70% by mole base on the total structure units in the liquid crystal polymer.

5. The method according to claim 1, wherein the filler is contained in the resin composition in the amount of from 1 to 98% by weight based on the total amount of the filler and the powder of the liquid crystal polymer.

6. The method according to claim 1, wherein the filler is a filler comprising an inorganic material having a coefficient of thermal conductivity of 10 W/mK or more at a temperature of 20° C.

7. The method according to claim 6, wherein the filler having a coefficient of thermal conductivity of 10 W/mK or more contains alumina as a main component.

8. A molded article obtained by the method according to claim 1.

9. The molded article according to claim 8, wherein the molded article has a specific dielectric constant of 4.5 or more at a measurement frequency of 1 GHz.

10. The molded article according to claim 8, wherein the molded article has a specific dielectric constant of 2.8 or less at a measurement frequency of 1 GHz.

11. A circuit board comprising the molded article obtained by the method according to claim 1 and a conductive circuit layer formed thereon.
